(19) United States
(12) Patent Application Publication
(10) Pub. No.: US 2019/0128352 A1
(43) Pub. Date: May 2, 2019

(54) Brake Pad Monitor with Wireless Connectivity

(71) Applicants: Robert Bosch LLC, Broadview, IL (US); Robert Bosch GmbH, Stuttgart (DE)

(72) Inventors: Vivek Jain, Sunnyvale, CA (US); Abtin Keshavarzian, Mountain View, CA (US); Hamidreza Mohseni, Naperville, IL (US); Mark Phipps, Wayne, IL (US)

(21) Appl. No.: 16/170,731

(22) Filed: Oct. 25, 2018

Related U.S. Application Data
(60) Provisional application No. 62/579,634, filed on Oct. 31, 2017.

(51) Int. Cl. F16D 66/02

(52) U.S. Cl. CPC F16D 66/027

(57) ABSTRACT

A wireless brake pad monitor system comprising a number of brake pad monitors operable to measure and monitor the physical state of a number of brake pads. Each brake pad monitor is further in wireless communication with at least one other brake pad monitor of the system. One brake pad monitor of the system may be configured to act as a coordinating member of the network to organize and command the other brake pad monitors.

### TECHNICAL FIELD

This disclosure relates to the monitoring of the physical state of a vehicle, and in particular the physical state of the brake pads of a vehicle. Monitoring of the physical state of the brake pads is performed using sensors to generate data that may be analyzed for diagnostic purposes.

### BACKGROUND

The invention provides a system to perform real-time monitoring of the physical state of vehicle brake pads. Vehicle brakes rely on friction to control the speed and motion of the vehicle. The friction surfaces of the brakes suffer mechanical wear and require maintenance and replacement under normal operating conditions. Vehicle brakes comprise brake pads to provide an expendable friction surface in order to effectively provide braking functions while also provide inexpensive replacement of the friction surfaces. Monitoring the physical state of the brake pads provides drivers and technicians useful information regarding whether the brake pads need replacement.

Conventional brake pads use passive wear indicators, such as metal tabs that contact a rotor when the friction surface wears away enough to allow contact and make a noise from the contact providing a notification to a driver, and do not comprise an active real-time monitoring system. It would be advantageous to have a network of brake pad monitors in communication with each other or a vehicle to provide data and feedback regarding the condition of the brake pads. This data and feedback may be useful for vehicle passengers and technicians to perform diagnostics or maintain the vehicle. Further, the operational capacity of an autonomous vehicle may not be directly observed by a driver, including the operational capacity of the brakes. Thus, it may be additionally advantageous to provide self-diagnostic functions and notifications of safety features, such as braking components, in autonomous vehicles that may not respond as well to traditional feedbacks provided in non-autonomous vehicles.

### SUMMARY

One aspect of this disclosure is directed to a brake pad monitor device that is operable to measure the physical deterioration of a vehicular brake pad, and further operable for wireless communication between at least one other such brake pad monitor device.

According to another aspect of this disclosure, some embodiments of brake pad monitors may comprise energy harvesting functions.

Another aspect of this disclosure is directed to a system of system of brake pad monitors in wireless data communication, wherein one of the brake pad monitors operates in a primary control operating mode to coordinate the operations of the other brake pad monitors operating in a secondary subordinate operating mode.

A further aspect of this disclosure is directed to a method of power load balancing in a system of brake pad monitors having wireless data communication functions, the method being operable to optimize power consumption of the brake pad monitors.

The above aspects of this disclosure and other aspects will be explained in greater detail below with reference to the attached drawings.

### BRIEF DESCRIPTION OF THE DRAWINGS

FIG. 1 is a diagrammatic view of a brake pad monitor device.

FIG. 2 is a diagrammatic illustrations of a brake pad monitor system.

FIG. 3 is a flowchart showing a load-balancing method for a brake pad monitor system.

FIG. 4 is a diagrammatic illustration of a brake pad monitor system.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

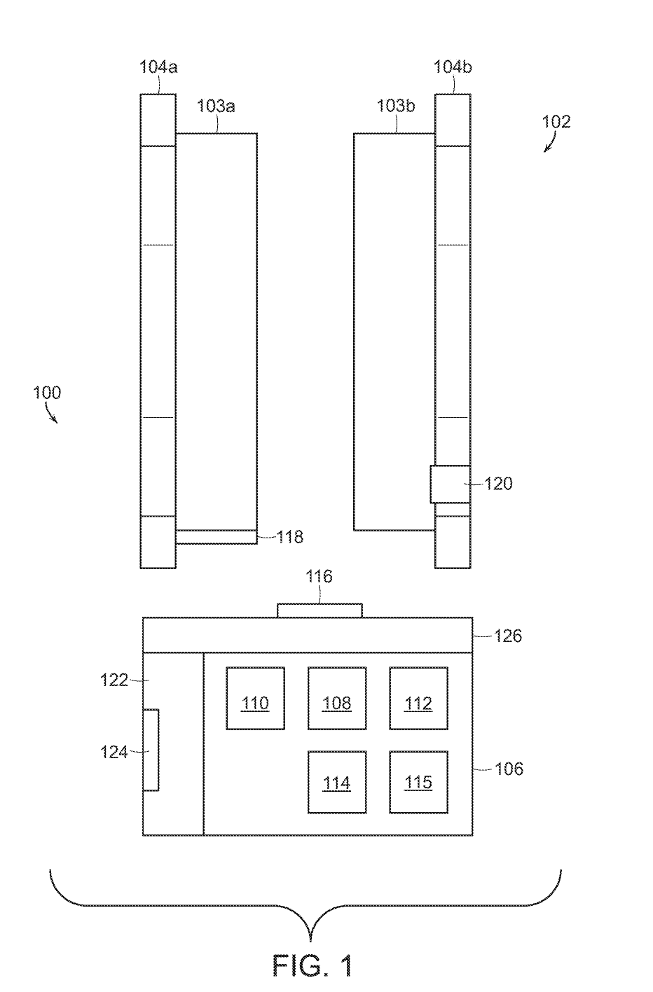

FIG. 1 shows a diagrammatic view of a vehicle brake pad monitor 100 operable to monitor the physical conditions of a vehicle brake 102. In the depicted embodiment, vehicle brake 102 comprises a set of brake pads 103, each of brake pads 103 mounted to a backing plate 104. In the depicted embodiment vehicle brake 102 comprises a pair of brake pads 103a-b respectively mounted to a pair of backing plates 104a-b, but other embodiments may comprise other configurations. Conventional brake configurations work with multiple brake pads arranged in opposition, such as in a caliper of a disk brake assembly where the brake pads are squeezed toward each other with a rotor in-between. Other brake configurations work with multiple brake pads arranged around a circumference, such as in a drum brake assembly where the brake pads are forced outwardly from the center point into an inner circumference of a drum. Yet other brake pads may be used to contact a drive shaft directly, or engage with a face of a rotating surface such as a clutch style brake, while other embodiments may comprise even other arrangements, such as a design utilizing a single brake pad. Brake pads 103 comprise a friction lining operable to press against a wheel, rotor, drum, shaft, clutch plate, or other rotating component of a vehicle in order to slow or halt the rotations that enable locomotion, and all embodiments and teachings herein may be utilized or adapted to work with the varying systems. To prevent damage to the rotating component of the vehicle, brake pads 103 are designed to erode from the abrasion and friction forces applied during normal use. In the depicted embodiment, brake pads 103 are situated to clamp around a wheel rotor (not shown). Brake pad monitor 100 is operable to measure the physical deterioration of brake pads 103 by monitoring their physical state.

Brake pad monitor 100 comprises a wireless unit 106 housing a pad processor 108, a memory 110, transmitter 112 and a receiver 114. Pad processor 108 controls the functions of the other components of brake pad monitor 100, and in some embodiments may be operable to perform analysis or diagnostic functions. Memory 110 may provide instructions to pad processor 108, or may be used to store data useful to the functions of brake pad monitor 100, such as data identifying the location of brake pad monitor 100 within the vehicle (e.g., front right wheel, etc.). In some embodiments, memory 110 may comprise a unique identification value describing brake pad monitor 100, for use to identify the brake pad monitor 100 when implemented within a network. Transmitter 112 and receiver 114 provide wireless communication functions to pad processor 108. Transmitter 112 and receiver 114 may be configured to communicate wirelessly with other devices via one or more of a Bluetooth specification, an RF (radio frequency) specification, cellular phone channels (analog or digital), cellular data channels, a Wi-Fi specification, a satellite transceiver specification, infrared transmission, a Zigbee specification, Local Area Network (LAN), Wireless Local Area Network (WLAN), a proprietary wireless network, or any other alternative configuration, protocol, or standard known to one of ordinary skill in the art. In some embodiments, transmitter 112 and receiver 114 may be embodied as single transceiver operable to both transmit and receive wireless signals. In the depicted embodiment, wireless unit 106 is disposed away from vehicle brake 102, but other embodiments may comprise other arrangements, such as wireless unit 106 being coupled to vehicle brake 102, associated brake calipers, the wheel or rotor, or any other arrangement known to one of ordinary skill in the art. In the depicted embodiment, wireless unit 106 further comprises a fidelity indicator 115, operable to measure the wireless connection fidelity between brake pad monitor 100 and other wireless devices and to generate fidelity data reflecting the wireless connection fidelity. Fidelity indicator 115 may be operable to generate fidelity data in the form of a single set of data corresponding to all wireless connectivity, or may be operable to generate separate sets of data corresponding to transmitter 112 and receiver 114 individually. In some embodiments, fidelity indicator 115 may be operable to generate sets of data that are distinct to any individual wireless device to which brake pad monitor 100 communicates wirelessly. In some embodiments, pad processor 108 may be operable to sort, analyze, or otherwise process the fidelity data generated by fidelity indicator 115.

Pad processor 108 is operable to control a number of pad sensors, the sensors being operable to provide data corresponding to the physical state and conditions of the brake pads 103. In the depicted embodiment, the pad sensors comprise an optical sensor 116, a thickness sensor 118 or a pressure sensor 120. In the depicted embodiment, brake pad monitor 100 comprises all of these sensors, but other embodiments may have other configurations comprising additional sensors or fewer sensors.

Optical sensor 116 may be configured to track an optical distance measurement of the thickness of brake pads 103. In some embodiments, optical sensor 116 may be configured to measure abrasion or optical density of the surface of brake pads 103. In the depicted embodiment, optical sensor 116 coupled to wireless unit 106, but other embodiments may comprise other arrangements. In some embodiments, optical sensor 116 may additionally measure other conditions detectable using optical emissions, such as infrared heat or reflectivity of the surfaces of vehicle brake 102. Some embodiments may comprise a plurality of optical sensors 116, arranged to optimize measurement of brake pads 103.

Thickness sensor 118 may be configured to directly measure the thickness of brake pads 103. In the depicted embodiment thickness sensor 118 is arranged alongside brake pad 103a, but other embodiments may have other arrangements, such as disposed within one of brake pads 103, or any other equivalent configuration known to one of ordinary skill in the art. In the depicted embodiment, thickness sensor 118 comprises a contact sensor operable to generate an electrical signal correlating to its thickness. For example, thickness sensor 118 may be comprised of a resistive material having a resistivity correlating to the thickness of the material. Thus, a consistent voltage applied to thickness sensor 118 may generate an increasing current draw during contact as the sensor erodes by friction. In such an embodiment, thickness sensor 118 may be configured to erode at substantially the same rate as brake pads 103. In some embodiments, thickness sensor 118 may be operable to generate other data useful for monitoring vehicle brake 102, such as the surface temperature of the rotor during active braking. Some embodiments may comprise a plurality of thickness sensors 118, arranged to optimize the measurement of brake pads 103.

Pressure sensor 120 may be configured to measure the mass of brake pads 103. In the depicted embodiment pressure sensor 118 is disposed between brake pad 103b and backing plate 104b, but other embodiment may have other arrangements. In the depicted embodiment, pressure sensor 120 measures the mass of brake pad 103b based upon the forces applied by brake pad 103b to backing plate 104b. As brake pad 103b is eroded by friction forces, pressure sensor 120 will measure a decreasing mass of brake pad 103b. In some embodiments, pressure sensor 120 may be operable to generate other data useful for monitoring vehicle brake 102, such as the pressure applied by vehicle brake 102 to the wheel or rotor. In the depicted embodiment, pressure sensor 120 is only operably coupled to brake pad 103b, but other embodiment may comprise additional pressure sensor arrangements, such as at least one pressure sensor 120 for each brake pad 103 utilized. Some embodiments may comprise a plurality of pressure sensors 120 for each brake pad 103, arranged to optimize the measurement of each brake pad 103.

Pad processor 108 is operable to collect the data generated by the sensors. In some embodiments, pad processor 108 may be operable to perform analysis using the collected data. In some embodiments, the data generated by the sensors may be stored in memory 110. In some embodiments, pad processor 108 may be operable to transmit the collected data to an external processor for analysis via transmitter 112. In some embodiments, pad processor 108 may be operable to perform analysis on the collected data or transmit the collected data depending on an active operational mode of pad processor 108. In some embodiments, pad processor 108 is operable to transmit commands to an external processor using transmitter 112 or receive commands from an external processor via receiver 114.

The components of brake pad monitor 100 are powered by a power supply 122. In the depicted embodiment, power supply 122 comprises a rechargeable battery, but other embodiments may comprise other configurations such as a capacitive power supply, an electric generator, or hardwire connection to an external power source. In the depicted embodiment, power supply 122 further comprises an electric charge sensor 124 operable to generate charge data corresponding to the total electric power that power supply 122 is currently operable to deliver to the components of brake pad monitor 100. The charge data may be utilized by pad processor 108 for analysis, or transmitted to an external processor using transmitter 112. In the depicted embodiment, all components of brake pad monitor 100 are powered by power supply 122, including the components housed within wireless unit 106, and the sensors 116, 118, and 120. In some embodiments, some components may be powered by other means.

In the depicted embodiment, brake pad monitor 100 further comprises an energy harvester 126. Energy harvester 126 is operable to generate electric power using the environmental conditions surrounding brake pad monitor 100. Energy harvester 126 may comprise a kinetic energy transducer, a thermal energy transducer, a radio frequency (RF) energy transducer, a piezoelectric transducer, or any other equivalent embodiment known to one of ordinary skill in the art without deviating from the disclosure herein. For example, in some embodiments energy harvester 126 may comprise a kinetic energy transducer that is operable to generate electric power when the vehicle brake 102 is engaged, slowing forward motion of the vehicle and shifting vehicular momentum to release harvestable energy. In another example, in some embodiments energy harvester 126 comprises a thermal transducer operable to generate electric energy by converting thermal energy in the form of heat in the environment of the vehicle brake 102, such as the heat generated by the friction forces when the brake pads 103 are pressed to the rotors. In another example, in some embodiments energy harvester 126 comprises an RF transducer operable to converter RF energy from wireless transmissions into electrical energy. RF transmission may include the wireless transmissions to and from the brake pad monitor 100 using transmitter 112 and receiver 114 respectively, but may also include RF transmissions in the environment unrelated to the operation of brake pad monitor 100, such as terrestrial radio broadcasts. In a further example, in some embodiments energy harvester 126 may comprise a piezoelectric transducer that is operable to generate electrical energy when brake pads 103 are compressed against the wheels or rotors during a braking operation. Other embodiments may comprise other forms of energy harvester 126 known to one of ordinary skill in the art without deviating from the teachings disclosed herein. In the depicted embodiment, energy harvester 126 is depicted as being coupled to wireless unit 106, but other embodiments may comprise other arrangements without deviating from the teachings disclosed herein. Some embodiments may comprise more than one energy harvester 126, either of a single form or of a variety of forms. In some such embodiments, individual components of brake pad monitor 100 may be independently powered by one of the plurality of energy harvesters 126. In some embodiments, energy harvester 126 may generate enough electrical power such that power supply 122 is unnecessary for proper function of the other components of brake pad monitor 100. In some such embodiments, brake pad monitor 100 may not comprise a power supply 122. In the depicted embodiment, energy harvester 126 is operable to charge power supply 122, including recharging power supply 122 when electric charge sensor 124 indicates that power supply 122 is below its full charge capacity.

In the depicted embodiment, brake pad monitor 100 may be operated in a plurality of operating modes. In a primary control operating mode, pad processor 108 functions to coordinate collaborative functions of a network of brake pad monitors 100. In a secondary support mode, pad processor 108 functions as a subordinate process in a network, its functions being coordinated by another brake pad monitor 100 operating in the primary control mode. Other embodiments may comprise other modes of operation, such as an independent mode for brake pad monitors that are not part of a network of other brake pad monitors.

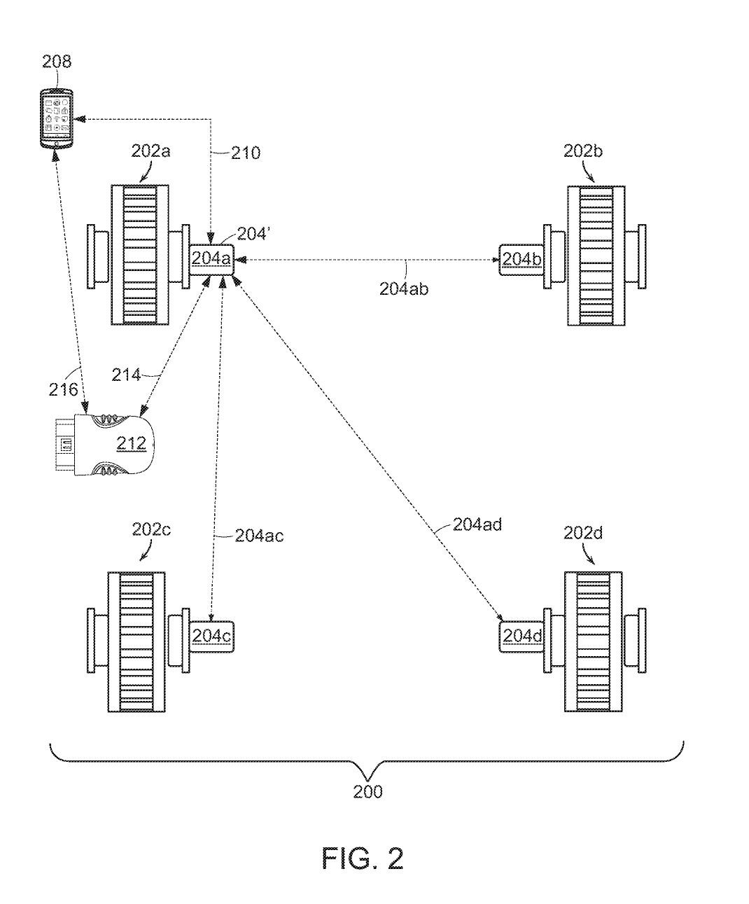

FIG. 2 is a diagrammatic view of a brake pad monitor system 200 operable to monitor a number of brake assemblies 202 using a number of brake pad monitors 204. Brake assemblies 202a, 202b, 202c, and 202d are designed to have identical operability at installation. In practice, each of brake assemblies 202a, 202b, 202c, and 202d may wear at different rates because of non-identical environmental and wear conditions during use. In the depicted embodiment, each of brake assemblies 202 represent the brake assemblies of a four-wheeled motor vehicle, but other embodiments may comprise other vehicles without deviating from the teachings disclosed herein. In the depicted embodiment, brake pad assemblies 202 comprise brake pads 103 (see FIG. 1) and the rotor of a wheel, but other embodiments may comprise other configurations without deviating from the teachings disclosed herein. In the depicted embodiment, each of brake pad monitors 204a, 204b, 204c, and 204d represent an embodiment of brake pad monitor 100 (see FIG. 1). Each of brake pad monitors 204a, 204b, 204c, and 204d are operable to perform identical functions, and in practice may differ in operation because of their active operating modes. In the disclosure herein, a brake pad monitor 204 operating in a primary control mode shall be referred to as a primary mode monitor 204′. The label of primary mode monitor 204′ does not refer to a particular brake pad monitor 204 within brake pad monitor system 200, but instead reflects an operating mode of any of brake pad monitors 204. With respect to FIG. 2, brake pad monitor 204a is operating in the primary control mode, and thus is additionally labeled as primary mode monitor 204′.

In the depicted embodiment, brake pad monitor 204a is the primary mode monitor 204′ operating in a primary control mode, and is coordinating the functions of brake pad monitors 204b, 204c, and 204d. When serving as primary mode monitor 204′, brake pad monitor 204a wirelessly communicates with brake pad monitor 204b using a monitor channel 206ab. Monitor channel 206ab exists when brake pad monitor 204a is in the primary control mode and brake pad monitor 204b is in the secondary support mode. When serving as primary mode monitor 204′, brake pad monitor 204a wirelessly communicates with brake pad monitor 204c using a monitor channel 206ac. Monitor channel 206ac exists when brake pad monitor 204a is in the primary control mode and brake pad monitor 204c is in the secondary support mode. When serving as primary mode monitor 204′, brake pad monitor 204a wirelessly communicates with brake pad monitor 204d using a monitor channel 206ad. Monitor channel 206ad exists when brake pad monitor 204a is in the primary control mode and brake pad monitor 204d is in the secondary support mode. In the depicted embodiment, only one of brake pad monitors 204 may serve as primary mode monitor 204′ and operate in the primary control mode. The remaining brake pad monitors 204 within the network operate in the secondary subordinate mode. Other embodiments may comprise other configurations. One such configuration may comprise a number of sub-networks, each of the sub-networks having a respective primary mode monitor 204′ to coordinate an additional number of brake pad monitors operating in the secondary subordinate mode. In some such embodiments, primary mode monitors 204′ may each communicate directly with an external processor. In some such embodiments, one brake pad monitor 204 may operate in a third mode to which the primary mode monitors 204′ are subordinate, the third mode being operable to collate the generated data sets from each subnetwork. Such embodiments may be advantageous for use with vehicles having a larger quantity of brake pads (e.g., an eighteen-wheel truck).

As depicted in FIG. 2, each of brake pad monitors 204 perform measurements of the conditions pertaining to their respective brake assembly 202. For example, each of brake pad monitors 204 may make regular measurements of the physical state of brake pad 103 at timed intervals to generate measurement data. Brake pad monitors 204b, 204c, and 204d may then transmit their respective resulting generated measurement data to brake pad monitor 204a, which in the depicted embodiment serves as primary mode monitor 204′. Primary mode monitor 204′ receives the generated measurement data from brake pad monitors 204b, 204c, and 204d, and collates that generated measurement data in addition to the measurement data generated from its own sensor measurements to form a set of collated data. The primary mode monitor 204′ may then analyze the collated data using pad processor 108 (see FIG. 1) to generate analysis results, or may transmit the collated data to a diagnostic processor 208 external to brake pad monitor 204a. In some embodiments, primary mode monitor 204′ may analyze the collated data to generate analysis results and then transmit the analysis results to diagnostic processor 208 instead of, or in addition to, the collated data.

Primary mode monitor 204′ may be further operable to transmit control commands to the other brake pad monitors (brake pad monitors 204b, 204c, and 204d as depicted in FIG. 2) in the secondary subordinate mode. Control commands may include commands to generate measurement data, commands to transmit the most recent generated measurement data, commands to transmit a report of wireless connection fidelity status, or commands to change the active operating mode. Other embodiments may comprise other commands without deviating from the teachings of the disclosure herein.

The primary mode monitor 204′ is further operable to connect wirelessly to an external processor, such as the diagnostic processor 208 via diagnostic channel 210. Diagnostic channel 210 exists between diagnostic processor 208 and the primary mode monitor 204′ (e.g., brake pad monitor 204a in the depicted embodiment of FIG. 2). In the depicted embodiment, diagnostic processor 208 comprises a smartphone, but other embodiments may comprise a tablet computing device, a desktop computer, a laptop computer, a specialized processor, a handheld device, or any other equivalent alternative known to one of ordinary skill in the art without deviating from the teachings disclosed herein. In some embodiments, diagnostic processor 208 may be operable to receive data transmitted by a primary mode monitor 204′. In some embodiments, diagnostic processor 208 is operable to perform analysis upon the data received from primary mode monitor 204′. In some embodiments, diagnostic processor 208 is operable to transmit commands to a primary mode monitor 204′, such as control commands intended for the primary mode monitor 204′ (e.g., brake pad monitor 204a in FIG. 2), control commands to be relayed to the other brake pad monitors 204 operating in the secondary subordinate mode (e.g., brake pad monitors 204b, 204c, and 204d in FIG. 2), or other commands to perform other functions of the diagnostic processor 208. In some embodiments, diagnostic processor 208 is connected to an external analytics processor (not shown), which may perform the analysis upon the data received from the primary mode monitor 204′, or collect the data of multiple brake pad monitor systems 200 for more advanced analysis or analysis using a larger data set. The external analytics processor may be a desktop computer, a laptop computer, a mainframe computer, a central network server, a distributed computing network, a cloud-based processing network, or any other arrangement of a number of network-enabled processors known to one of ordinary skill in the art without deviating from the teachings disclosed herein.

In the depicted embodiment, primary mode monitor 204′ is further operable to connect wirelessly to a vehicle processor 212 instead of, or in addition to, diagnostic processor 208. In the depicted embodiment, vehicle processor 212 is operable to perform some or all of the functions of diagnostic processor 208. In some embodiments, vehicle processor 212 may be operable to perform additional functions beyond what functions diagnostic processor 208 is capable, or vice-versa. A vehicle channel 214 exists between vehicle processor 212 and a primary mode monitor 204′ (e.g., brake pad monitor 204a in the depicted embodiment). In the depicted embodiment, vehicle processor 212 is embodied within a dongle device configured to interface with the diagnostic port of a vehicle (e.g., an OBD-II port), but other embodiments may comprise other configurations of vehicle processor 212 such as an on-board vehicle processor, a native processor disposed within a vehicle head unit, an aftermarket processor installed in the vehicle, a telematics system, or any other equivalent alternative known to one of ordinary skill in the art without deviating from the teachings disclosed herein. In some embodiments, vehicle processor 212 may be operable to receive data transmitted by a primary mode monitor 204′. In some embodiments, vehicle processor 212 is operable to perform analysis upon the data received from a primary mode monitor 204′. In some embodiments, vehicle processor 212 is operable to transmit commands to a primary mode monitor 204′, such as control commands intended for the primary mode monitor 204′ (e.g., brake pad monitor 204a in FIG. 2), control commands to be relayed to the other brake pad monitors 204 operating in the secondary subordinate mode (e.g., brake pad monitors 204b, 204c, and 204d in FIG. 2), or other commands to perform other functions of the vehicle processor 212. In some embodiments, diagnostic processor 208 is connected to an external analytics processor (not shown), which may perform the analysis upon the data received from the primary mode monitor 204′, or collect the data of multiple brake pad monitor systems 200 for more advanced analysis or analysis using a larger data set. The external analytics processor may be a desktop computer, a laptop computer, a mainframe computer, a central network server, a distributed computing network, a cloud-based processing network, or any other arrangement of network-enabled processors known to one of ordinary skill in the art without deviating from the teachings disclosed herein. In some embodiments, the same external analytics processor may be in communication with both diagnostic processor 208 and vehicle processor 212, but other embodiments may have other configurations.

In the depicted embodiment, diagnostic processor 208 and vehicle processor 212 are in wireless communication using an interconnect channel 216. Interconnect channel 216 may provide a communication channel that makes diagnostic processor 208 and vehicle channel 212 operable to each contribute to the functions thereof without redundant operations. In some embodiments, interconnect channel 216 may enable diagnostic processor 208 and vehicle processor 212 to operate in a cooperative manner with respect brake pad monitors 204. In some embodiments, only one of diagnostic processor 208 or vehicle processor 212 may be present. In some embodiments, multiple additional processors of varying types may be included instead of, or in addition to diagnostic processor 208 or vehicle processor 212.

A primary mode monitor 204′ may expend extra power performing the additional transmissions to each of the other brake pad monitors 204 in a secondary subordinate mode, or the additional transmissions to one of diagnostic processor 208 or vehicle processor 212. Additionally, if the wireless connection fidelity between a primary mode monitor 204′ and another element of brake pad monitor system 200 is poor, the primary mode monitor 204′ may expend extra power in accurately transmitting or receiving data or commands. Advantageously, a primary mode monitor 204′ may initiate a load-balancing procedure to shift itself into the secondary subordinate mode after nominating another of brake pad monitors 204 in brake pad monitor system 200 to operate in the primary control mode. This load-balancing procedure effectively shifts the status of primary mode monitor 204′ to a different one of the brake pad monitors 204 within brake pad monitor system 200. Advantageously, the load-balancing procedure may extend the operability of brake pad monitor system 200 by optimizing power consumption, thereby minimizing the risk of failure in the system caused by an expended power supply 122 (see FIG. 1) of any single brake pad monitor 204. In a further advantage, embodiments which adjust the operating mode of the brake pad monitors 204 based upon wireless connection fidelity may improve reliability of transmissions between the elements of brake pad monitor system 200.

In some embodiments, the load-balancing procedure may be initiated based upon the electric charge status indicated by the electric charge sensor 124 (see FIG. 1) of the primary mode monitor 204′. In some embodiments, the primary mode monitor 204′ may initiate the load-balancing procedure when its respective power supply 122 (see FIG. 1) has an electric charge level below a threshold value. In some embodiments, the primary mode monitor 204′ may initiate the load-balancing procedure when the differential changes to its electric charge level indicate that its respective power supply 122 is draining at a rate faster than a threshold rate. In some embodiments, the primary mode monitor 204′ may initiate the load-balancing procedure when the differential changes to its electric charge level indicate that its respective power supply 122 is draining at a rate faster than another brake pad monitor 204 within brake pad monitor system 204′. In some embodiments, a round-robin implementation may cause a primary mode monitor 204′ to initiate a load-balancing procedure after serving as the primary mode monitor 204′ for a pre-configured length of time. In some embodiments, the primary mode monitor 204′ may initiate the load-balancing procedure based upon the indicated wireless connection fidelity status between the primary mode monitor 204′ and one or more of the other elements of brake pad monitor system 200. For example, in one embodiment the primary mode monitor 204′ may generate wireless fidelity data indicating that the connection fidelity of a wireless channel between the primary mode monitor 204′ and another element of brake pad monitor system 200 is below a threshold value. In another example, in an embodiment the primary mode monitor 204′ may determine that the wireless connection fidelity of another brake pad monitor 204 of brake pad monitor system 200 is superior to that of the primary modem monitor 204′. In such conditions, primary mode monitor 204′ may initiate the load-balancing procedure. In some embodiments, the load-balancing procedure may be initiated in response to an operational event of the vehicle, such as an extended braking function, or a direct command from a human user via a human interface of the diagnostic processor 208 or vehicle processor 212.

Selection of the next brake pad monitor 204 to serve as the primary mode monitor 204′ during the load-balancing procedure may be performed based upon the conditions of brake pad monitor system 200. In one embodiment, the brake pad monitor 204 having the highest electric charge indicated by its respective electric charge sensor 124 may be selected. In one embodiment, the brake pad monitor 204 having the highest wireless connection fidelity indicated by its respective fidelity indicator 115 (see FIG. 1) with one or more other elements of brake pad monitor system 200 (or other relationships, such as a highest average fidelity amongst all connections) may be selected. In some embodiments, a predetermined sequence of the brake pad monitors 204 may dictate the order in which each brake pad monitor is selected. In some embodiments, the next brake pad monitor 204 may be selected using an arbitrary, random, or pseudo-random methodology. In some embodiments, the next brake pad monitor 204 to act as the primary mode monitor 204′ may be selected by a human user via a human interface of diagnostic processor 208 or vehicle processor 212. Some embodiments may be operable to use more than one of the above methods for determination of the next brake pad monitor 204 to serve as primary mode monitor 204′.

Selection of a brake pad monitor 204 to serve as an initial primary mode monitor 204′ may be required in some embodiments. Initial selection of the primary mode monitor 204′ may be a one-time event upon installation or initialization of brake pad monitor system 200 or may be routinely performed. In some embodiments, the initial selection of a primary mode monitor 204′ is performed upon each engine startup of the vehicle. In some embodiments, the initial selection of a primary mode monitor 204′ is determined by vehicle processor 212 upon initial activation of vehicle processor 212. In some embodiments, the initial selection of a primary mode monitor 204′ is determined by diagnostic processor 208 upon initial activation of diagnostic processor 208. In some embodiments, one of brake pad monitors 204 may be designated by the system as the initial primary mode monitor 204′, and the system may utilize the load-balancing procedure to adjust operation of the brake pad monitor system 200 if the designated brake pad monitor 204 is not the optimal selection.

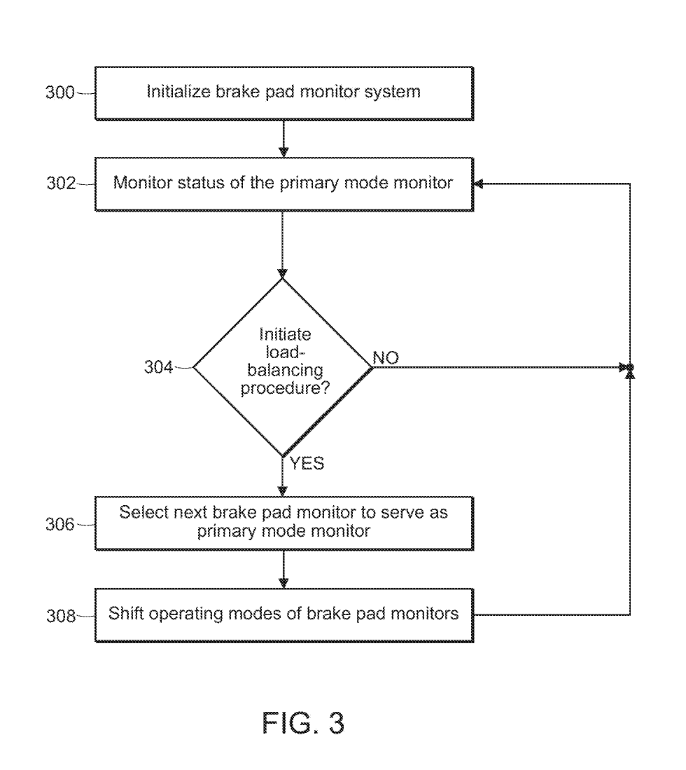

FIG. 3 is a flow chart depicting the steps of normal operation including a load-balancing procedure for brake pad monitor system, such as brake pad monitor system 200 (see FIG. 2), according to one embodiment of the teachings disclosed herein. In this embodiment, the embodiment of brake pad monitor system 200 performing the load-balancing procedure is depicted in FIG. 2, but one of ordinary skill in the art will recognize that other embodiments may have other configurations without deviating from the teachings disclosed herein. In a first step 300, a brake pad monitor system is initialized such that a brake pad monitor serves as a primary mode monitor and any remaining brake pad monitors operate in a secondary subordinate mode. After initialization, the brake pad monitor system continues with normal operation, wherein subordinate brake pad monitors transmit their generated data to the primary brake pad monitor. The primary brake pad monitor then collates the transmitted data with its own generated data for transmission to a vehicle processor for analysis. During this normal operation, the brake pad monitor system enters step 302, wherein the primary brake pad monitor monitors a status of the primary brake pad, such as its power supply status, via its electric charge sensor for example, or its wireless connection fidelity with each of the secondary brake pad monitors or the vehicle monitor, with its fidelity indicator for example. If a threshold value of a status indicator is met or exceeded, the flow chart moves into a decision block.

At step 304, the primary brake pad monitor initiates a load-balancing procedure, such as if its power supply 122 has an electric charge lower than the threshold level or if its fidelity indicator shows wireless connection fidelity between itself as primary mode monitor and another element of the brake pad monitor system is below a threshold value. If neither condition is met, the system returns to step 302 to continue normal operation and monitoring of the status of primary brake pad monitor. Other embodiments may comprise other reasons for the primary mode monitor to initiate the load-balancing procedure.

If the primary mode monitor initiates the load-balancing procedure, the system continues to step 306 where the primary brake pad monitor selects which of the secondary brake pad monitors 204 shall serve as the next primary mode monitor. The selection of the next primary mode monitor may be in response to the reason for initiating the load-balancing procedure. For example, if primary brake pad monitor initiates the load-balancing procedure in response to low power, the selection of the next primary mode monitor may be based upon which of the secondary brake pad monitors has a power supply with the greatest remaining electric charge. In another example, if the primary brake pad monitor initiates the load-balancing procedure in response to poor wireless connection fidelity, the selection of the next primary mode monitor may be based upon which of the secondary brake pad monitors indicating the greatest wireless connection fidelity. Some embodiments may select the next primary mode monitor in response to other causes of initiating the load-balancing procedure.

At step 308, the operating modes of the brake pad monitors are adjusted to operate with the next primary mode monitor in control, and the logic flow is transferred to the new primary brake pad monitor. Accordingly, the former primary brake pad monitor shifts from a primary control mode to a secondary subordinate mode. The brake pad monitor selected as the next primary mode monitor shifts from a secondary subordinate mode to the primary control mode. By way of example, and not limitation, if brake pad monitor 204b has been selected as the next primary mode monitor 204′, then brake pad monitor 204b shifts into the primary control mode (see FIG. 2). After the next primary mode monitor has shifted into the primary control mode, it establishes wireless communication channels between the diagnostic processor, vehicle processor, and the remaining brake pad monitors. Thus, in the given example, brake pad monitor 204b establishes wireless communication establishes wireless communication channels between diagnostic processor 208, vehicle processor 212, and each of brake pad monitors 204a, 204c and 204d (see FIG. 2).

After the brake pad monitors shift their operation and establish the proper communication channels in step 308, the system returns to step 302 to resume normal operation and monitor for another initiation of the load-balancing procedure.

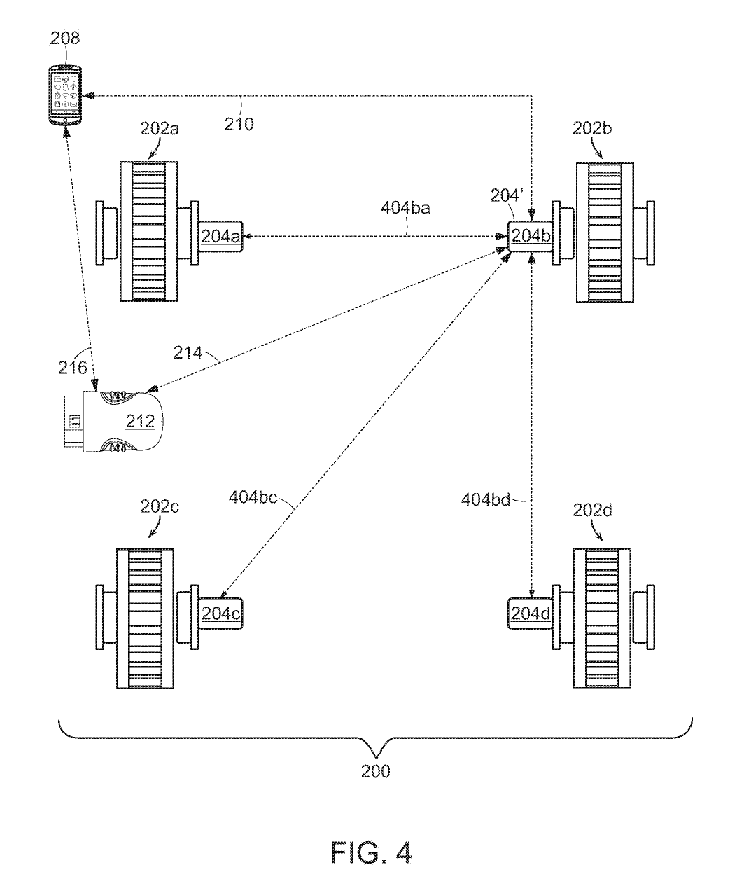

FIG. 4 is a diagrammatic view of the system of FIG. 2 after having completed the exemplary load-balancing procedure described above with respect to FIG. 3. In FIG. 4, the components of the system are mostly unchanged. However, in FIG. 4 brake pad monitor 204b is now serves as the primary mode monitor 204′ and brake pad monitor 204a is now operating in the secondary subordinate mode. Diagnostic channel 210 now connects diagnostic processor 208 to brake pad monitor 204b, and vehicle channel 214 now connects vehicle processor 212 to brake pad monitor 204b. However, it is noted that from an operational standpoint, each of diagnostic processor 208 and vehicle processor 212 are still in communication with the primary mode monitor 204′.

In FIG. 4, monitor channels 206ab, 206ac, and 206ad are no longer established. Instead, brake pad monitor 204b has established monitor channels with the other brake pad monitors 204. When serving as primary mode monitor 204′, brake pad monitor 204b now wirelessly communicates with brake pad monitor 204a using a monitor channel 406ba. Monitor channel 406ba exists when brake pad monitor 204b is in the primary control mode and brake pad monitor 204a is in the secondary support mode. When serving as primary mode monitor 204′, brake pad monitor 204b now wirelessly communicates with brake pad monitor 204c using a monitor channel 406bc. Monitor channel 406bc exists when brake pad monitor 204b is in the primary control mode and brake pad monitor 204c is in the secondary support mode. When serving as primary mode monitor 204′, brake pad monitor 204b now wirelessly communicates with brake pad monitor 204d using a monitor channel 406bd. Monitor channel 406bd exists when brake pad monitor 204b is in the primary control mode and brake pad monitor 204d is in the secondary support mode. FIG. 4 otherwise depicts an arrangement of brake pad monitor system 200 having the same operability as depicted with respect to FIG. 2, only in a different configuration after the load-balancing procedure. This particular configuration is provided as just one example of a successful completion of the load-balancing procedure, and is not intended to limit the teachings disclosed herein. One of ordinary skill in the art will recognize that other conditions of the disclosed embodiment may yield other arrangements of brake pad monitor system 200. One of ordinary skill in the art will further recognize that other embodiments may comprise other arrangements and configurations without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A vehicle brake pad monitor comprising:
a power supply;
a wear sensor powered by the power supply, the wear sensor configured to measure physical deterioration of the brake pad and generate deterioration data corresponding to the measurements;
a transmitter powered by the power supply, the transmitter operable to wirelessly transmit data including the generated deterioration data;
a receiver powered by the power supply, the receiver operable to wirelessly receive data including deterioration data transmitted from an external brake pad monitor; and
a pad processor powered by the power supply, the pad processor configured to operate in a primary mode or a secondary mode, wherein in the primary mode the pad processor is operable to receive deterioration data transmitted from a number of external brake pad monitors, compile the generated deterioration data and the received deterioration data into a set of deterioration data, and transmit the set of deterioration data to al vehicle processor, and wherein in the secondary mode the pad processor is operable to transmit the generated deterioration data.

2. The brake pad monitor of claim 1, wherein the power supply comprises an energy-harvester.

3. The brake pad monitor of claim 1, wherein the power supply comprises a battery.

4. The brake pad monitor of claim 3, wherein the battery further comprises a charge level sensor in data communication with the pad processor and operable to measure the charge level of the battery to generate charge data, and wherein the pad processor is further operable to transmit the charge data using the transmitter and its operating mode based upon the charge data.

5. The brake pad monitor of claim 4, wherein the pad processor when operating in the secondary mode is operable to transmit the charge data to another pad processor operating in the primary mode and further operable to begin operating in the primary mode when the receiver receives a primary mode operation command.

6. The brake pad monitor of claim 4, wherein the pad processor when operating in the primary mode is operable to transmit a primary mode operation command to another pad processor operating in a secondary mode and begin operating in the secondary mode when the charge data indicates that the charge level of the pad processor operating in the primary mode is lower than the charge level of the another pad processor operating in the secondary mode.

7. The brake pad monitor of claim 4, wherein the pad processor when operating in the primary mode is operable to transmit, using the transmitter, a primary mode operation command to another pad processor operating in a secondary mode and to begin operating in the secondary mode when the charge data indicates that the charge level of the battery is below a threshold value.

8. A brake pad monitor system of a vehicle, the brake monitor system comprising:
a plurality of brake pad monitors each operable to be coupled to a vehicular brake pad, each of the plurality of brake pad monitors comprising a pad processor and a wear sensor operable to measure the deterioration of its respective vehicular brake pad, wherein the plurality of brake pad monitors are in mutual wireless communication, and wherein the pad processor of one brake pad monitor of the plurality of brake pad monitors is operable to operate in a primary control mode and the remaining pad processors of the plurality of brake pad monitors are operable to operate in a secondary support mode subordinate to the pad processor in the primary control mode; and
a vehicle processor operable to be in data communication with a brake pad monitor having a pad processor in the primary control mode, the vehicle processor further in data communication with an electronic control unit of the vehicle.

9. The brake pad monitor system of claim 8, wherein the vehicle processor comprises a dongle attachment configured to be connected with a diagnostic port of the vehicle.

10. The brake pad monitors system of claim 8, wherein the vehicle processor comprises a portable processing device.

11. The brake pad monitor system of claim 8, wherein the vehicle processor is further operable to transmit control commands to the plurality of brake pad monitors, the control commands operable to adjust the operating mode of the pad processor of each brake pad monitor between the primary control mode and the secondary support mode.

12. The brake pad monitor system of claim 8, wherein the system further comprises a number of power supplies configured to provide power to the plurality of brake pad monitors, and wherein each of the plurality of brake pad monitors are configured to adjust the operating mode of its respective pad processor based upon the power made available to the respective brake pad monitor by the number of power supplies.

13. The brake pad monitor system of claim 12, wherein the number of power supplies comprise an energy harvester.

14. The brake monitor system of claim 8, wherein the data processor is further in data communication with a data store operable to store encrypted data, and wherein the data processor is operable to encrypt data transmitted to the data store using an encryption key generated using vehicle-specific information.

15. The brake monitor system of claim 8, wherein the data store comprises a cloud-based data store that is accessible to the data processor via the internet.

16. A method of power-load balancing for a system having a plurality of brake pad monitors, each of the plurality of brake pad monitors having a primary control operating mode and a secondary subordinate operating mode, the method comprising:
operating a first brake pad monitor in the primary control operating mode and the remaining plurality of brake pad monitors in the secondary subordinate operating mode, the primary control operating mode including coordinating the activity of the rest of the plurality of brake pad monitors in the secondary subordinate mode;
monitoring the power level or connectivity status of the first brake pad monitor and the power level or connectivity status of the rest of the plurality of brake pad monitors;
selecting a second brake pad monitor from the rest of the plurality of brake pad monitors when the power level or connectivity status of the first brake pad monitor falls below a threshold value;
shifting the operating mode of the first brake pad monitor from the primary control operating mode to the secondary subordinate operating mode and shifting the operating mode of the second brake pad monitor from the secondary subordinate operating mode to the primary control operating mode; and
operating the second brake pad monitor in the primary control operating mode and the remaining plurality of brake pad monitors including the first brake pad monitor in the secondary subordinate operating mode, the primary control operating mode including coordinating the activity of the remaining plurality of brake pad monitors in the secondary subordinate operating mode.

17. The method of claim 16, wherein the selecting a second brake pad monitor from the rest of the plurality of brake pad monitors comprises selecting the brake pad monitor having the highest power level as the second brake pad monitor.

18. The method of claim 16, wherein the selecting a second brake pad monitor from the rest of the plurality of brake pad monitors is performed when the power level of the first brake pad monitor falls below a threshold value.

19. The method of claim 16, wherein the selecting a second brake pad monitor from the rest of the plurality of brake pad monitors is performed when the connectivity status of the first brake pad monitor indicates that the first brake pad monitor has a connection fidelity with another of the plurality of brake pad monitors or an external data processor that is below a threshold fidelity metric.

20. The method of claim 16, wherein the selecting a second brake pad monitor from the rest of the plurality of brake pad monitors is performed when the connectivity status of the first brake pad monitor indicates that the first brake pad monitor has been operating in the primary control operating mode for longer than a threshold period of time.
